(19) United States
(12) Patent Application Publication
(10) Pub. No.: US 2009/0162460 A1
(43) Pub. Date: Jun. 25, 2009

(54) TIRE MOLD

(76) Inventors: Nicolas Daniel Dumont, Ethe (BE); Yacine Ouyahia, Bereldange (LU); Christopher Jean Alexis Pierre, Aubange (BE)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/257,434

(22) Filed: Oct. 24, 2008

Related U.S. Application Data
(60) Provisional application No. 61/015,386, filed on Dec. 20, 2007.

(51) Int. Cl. B29D 29/00

(52) U.S. Cl. 425/35

(57) ABSTRACT

The invention provides a mold comprising an annular cavity to mold a tire. The mold includes one or more sidewall plates, wherein at least one of said sidewall plates has a recessed channel having an inlet and an outlet, said sidewall plate having an inner surface in engagement with an annular surface of a container plate, wherein the recessed channel and the annular surface of the container plate form a fluid manifold, for circulating a fluid manifold for circulating a fluid medium. Alternatively, the channel may be located inside the sidewall plate.

This application claims the benefit of, and incorporates by reference, U.S. Provisional Application No. 61/015,386 filed Dec. 20, 2007.

### FIELD OF THE INVENTION

The present invention relates to a mold for a pneumatic radial tire, and more particularly, to a segmented tire mold.

### BACKGROUND OF THE INVENTION

Tire molds for molding pneumatic tires are typically constructed of steel or aluminum, and heated by steam platens or by placing the molds in potheaters. Thermal conduction is usually relied upon to transfer the heat from the heat source to the tread and sidewall forming surfaces. It is desirable to maximize the heat conduction to the tread and sidewall forming surfaces. If the thermal conduction is less than optimum, it will require additional cure time and energy costs resulting in reduced production capacity for the mold and higher operating costs. Inefficient thermal conduction can also result in temperature non-uniformity in the mold. The time to cure a tire is limited by the point of least cure on the tire, which is typically located on the undertread. For certain types of tires such as run flat tires, the point of least cure is often located in the bead apex area. Thus if this area could be cured quicker, the entire time of the process may be reduced. Thus an improved mold is desired which can heat the tire more quickly, uniformly and efficiently.

### SUMMARY OF THE INVENTION

The invention provides in a first aspect a mold comprising an annular cavity to mold a tire, the mold further comprising one or more sidewall plates, wherein at least one of said sidewall plates has an recessed channel having an inlet and an outlet, said sidewall plate having an inner surface in engagement with an annular surface of a container plate, wherein the recessed channel and the annular surface of the container plate form a fluid manifold, for circulating a fluid manifold for circulating a fluid medium.

The invention provides in a second aspect a mold comprising an annular cavity to mold a tire, the mold further comprising one or more sidewall plates, wherein at least one of said sidewall plates has an recessed channel having an inlet and an outlet, said sidewall plate having an inner surface in engagement with an annular surface of a container plate, wherein the recessed channel and the annular surface of the container plate form a fluid manifold, for circulating a fluid manifold for circulating a fluid medium.

### BRIEF DESCRIPTION OF THE DRAWINGS

The invention will be described by way of example and with reference to the accompanying drawings in which:

FIG. 1 is a partial cutaway view of a mold assembly showing only the segments, sidewall plates and mold rings;

FIG. 2 is a rear view of two segments;

FIG. 3 is a partial cutaway view of a complete tire mold assembly;

FIG. 4 is a partial cutaway view of the mold assembly of FIG. 1, with the actuator ring removed;

FIG. 5 is a perspective view of the mold shown in FIG. 4, with a portion of the slide blocks removed for clarity;

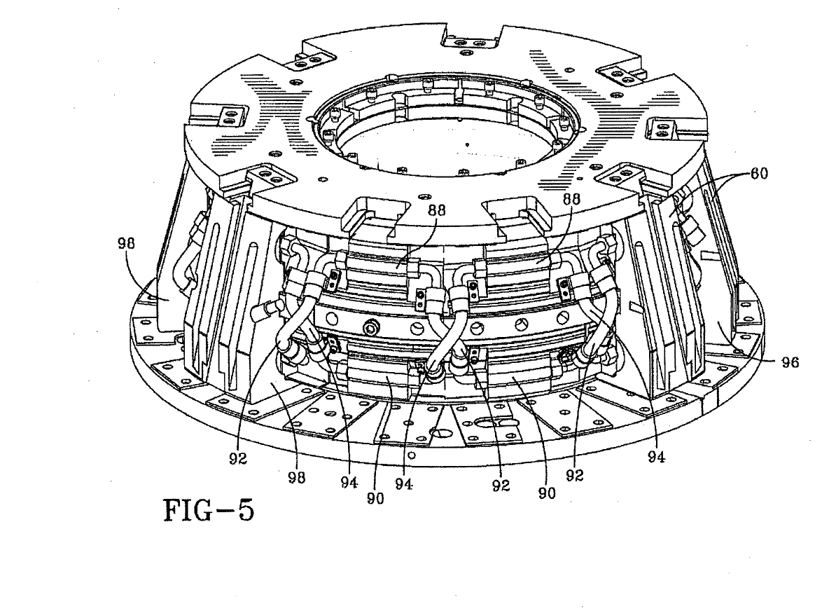

FIG. 6 is a perspective view of the entire assembly with the inner parts of the mold shown in phantom;

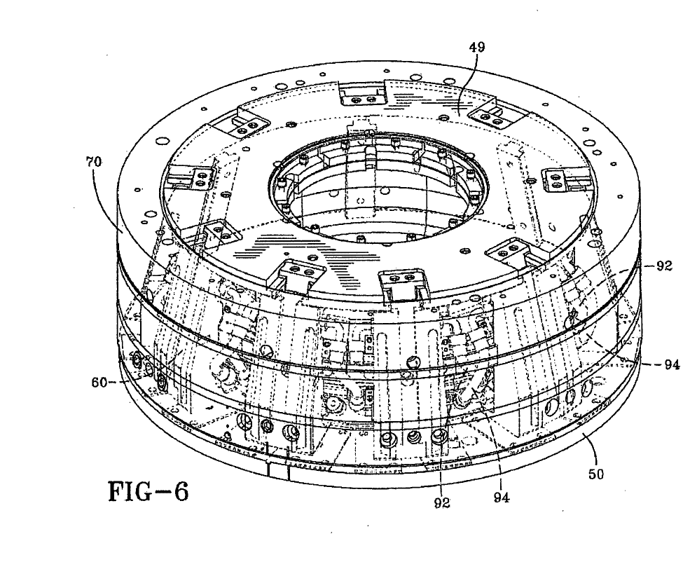

FIG. 7 is a perspective view of the flexible steam belt of the invention;

FIG. 8 is a rear view of a second embodiment of two segments;

FIG. 9 is a rear view of a coupling assembly and two cross members interconnecting the couplings.

FIG. 10 is a rear view of two segments showing the channels for insertion of the coupling assembly;

FIG. 11 is a perspective view of a lower sidewall plate and bottom container plate of the present invention;

FIG. 12 is a bottom perspective view of the lower sidewall plate of FIG. 11;

FIG. 13 is a cross-sectional view of the lower sidewall plate and a portion of the bottom container plate;

FIG. 14 is a top view of the lower sidewall plate and the bottom container plate;

FIG. 15 is a bottom view of the lower sidewall plate and the bottom container plate.

### DEFINITIONS

“Axial” and “axially” means the lines or directions that are parallel to the axis of rotation of the tire or tire mold.

“Circumferential” means lines or directions extending along the perimeter of the surface of the annular tread mold perpendicular to the axial direction.

“Radial” and “radially” mean directions radially toward or away from the axis of rotation of the tire or tire mold.

“Sidewall” means a portion of a tire between the tread and the bead.

### DETAILED DESCRIPTION OF THE INVENTION

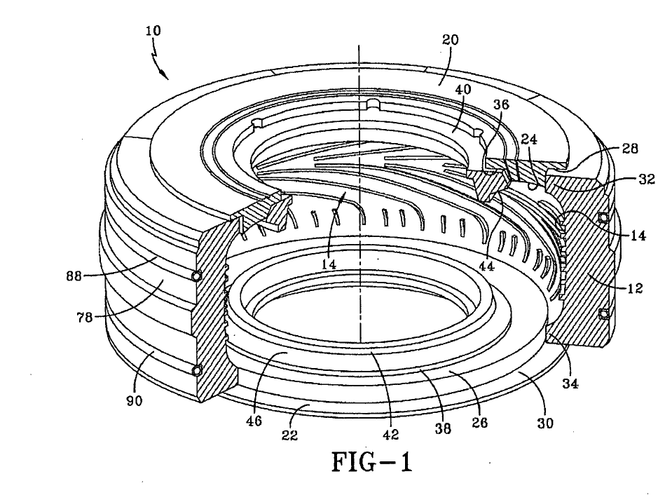

FIG. 1 illustrates a first embodiment of a mold assembly 10 of the present invention. The mold assembly 10 comprises a plurality of segments 12 which are arranged to form an annular ring when assembled together. The outer tread surface of a tire is formed by the inner molding surface 14 of the segments 12, which have a plurality of lands and grooves to mold the tread pattern in a green tire. The mold segments 12 may be radially movable to allow assembly and disassembly of the mold about a green tire.

The mold assembly 10 further comprises a first and second sidewall plate 20, 22 for molding the sidewalls of the tire (not shown). Each sidewall plate 20, 22 has an inner mold surface 24, 26 for molding the tire sidewall, and joins with the segments 12 to form a smooth continuous surface from the tire tread to the sidewall. Each sidewall plate 20, 22 has an optional radially outer lip 28, 30 forming an L shaped recess for receiving a first and second flanged end 32, 34 of the segment therein. Each sidewall plate 20, 22 further comprises an optional radially inner extension or lip forming a second L shaped recess 36, 38 for receiving a mold bead area 40, 42 therein. Each bead ring 40, 42 has a radiused portion 44, 46 for receiving a bead ring of a green tire thereon. The upper and lower sidewall plate 20, 22 together with the plurality of tread segments 12 and the top and bottom bead rings 40, 42 cooperate to define a mold cavity for molding a green tire.

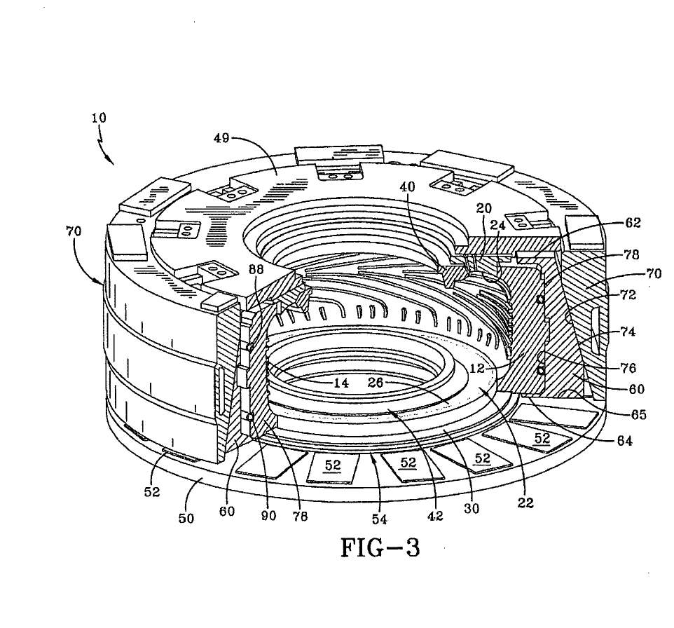

The mold assembly 10 is typically housed in an optional container housing 49 as shown in FIG. 3. The container 49 typically includes a bottom container plate 50 having a plurality of optional wear pads 52 thereon. The wear plate 50 has an inner annulus 54 for supporting the sidewall plate 22 and bead ring 42 thereon as shown in FIG. 3. The segments 12 are shown positioned about the sidewall plate 22. Surrounding the segments 12 are a plurality of slide blocks 60. The slide blocks 60 have flanged ends 62, 64 for receiving and supporting the segments 12 therein. The slide blocks 60 have a top and a bottom surface 62, 65 for contacting the container plates 49, 50 and wear plates 52. The slide blocks 60 are slidable in a radial direction. The container housing further comprises an annular actuating ring 70. The inner radial surface 72 of the actuating ring 70 is angled for engagement with an outer angled surface 74 of slide blocks 60. As the actuating ring 70 is lowered, the inner radial surface 72 of the actuating ring engages the outer surface 74 of slide blocks, causing the slide blocks to slide radially inward. The camming action of the actuator ring 70 moves the slide blocks 60 radially inward. As the slide blocks move radially inward, the radially inner surface 76 of the slide block engages the outer radial surface 78 of the adjacent segment, moving the segment radially inward as the actuating ring is lowered into position.

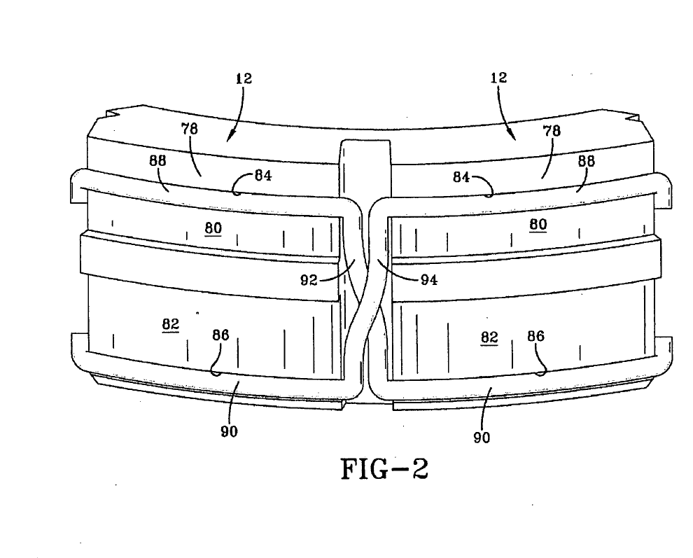

FIG. 2 illustrates a rear view of two of the tread mold segments of the present invention. The tread mold segments 12 have an outer radial surface 78 having a first or upper portion 80 and a second or lower portion 82. The first and second portions 80, 82 further comprise an open channel 84, 86 for receiving a tubular member 88, 90 respectively, therein. The tubular member 88, 90 may be flexible. As shown in FIG. 2, the tubular member is oriented for example, along the circumferential direction although other orientations may be utilized. It is preferred that the channel be deep enough so that the tubular member 88, 90 is flush or recessed when mounted in the channel. The open channels 84, 86 may be located in other locations such as the top and bottom surfaces of the tread segments or other location as desired.

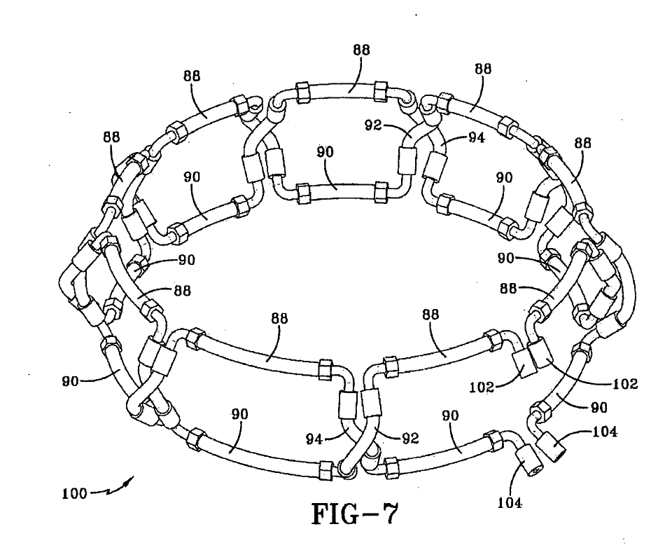

FIG. 7 illustrates the complete manifold assembly 100, wherein the mold has been removed for clarity. As shown in FIG. 7, the manifold assembly 100 comprises one or more inlet ports 102 and one or more outlet ports 104. Fluid such as steam enters the inlet port 102 and is routed through tubular members 88, 90. Tubular members 88, 90 are received in channels 84, 86 of a segment 12 and function to heat the segments by conduction of heat from the fluid flowing in the tubular segments 88, 90. A cross member 92 connects tubular member 88 on a first segment 12 to a lower tubular member 90 on an adjacent segment 12′. A second cross member 94 connects tubular member 88 to lower tubular member 90 on an adjacent segment. The cross members 92, 94 cross over each other where the segments are joined. Preferably the cross members 92, 94 are made of strong, flexible material such as polytetrafluorethylene (PTFE) reinforced with a stainless steel braid. This connection pattern is repeated for each segment. In the last segment, the upper and lower hose is joined together forming an outlet port. Because the segments move radially inward and outward, the hose segments must be flexible to accommodate the movement. As shown in FIG. 7, the upper tubular members 88 form a circle and are not joined together. The lower tubular members 90 also form a circle although they are not directly connected together.

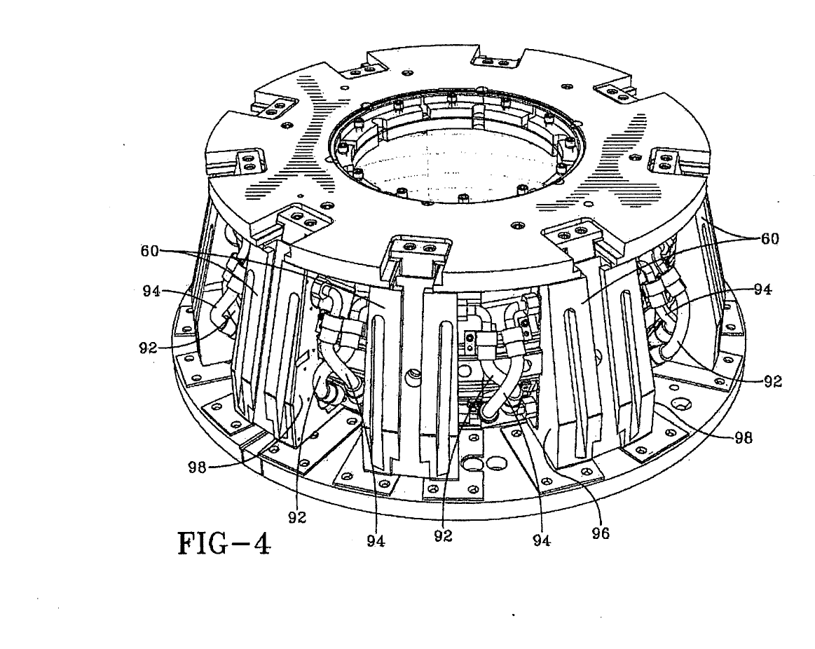

FIG. 4 illustrates the assembled mold with the actuating ring removed. The slide blocks 60 as shown have a reduced circumferential width so they appear staggered apart, and side faces 96,98 are not in contact with either other when the mold is assembled.

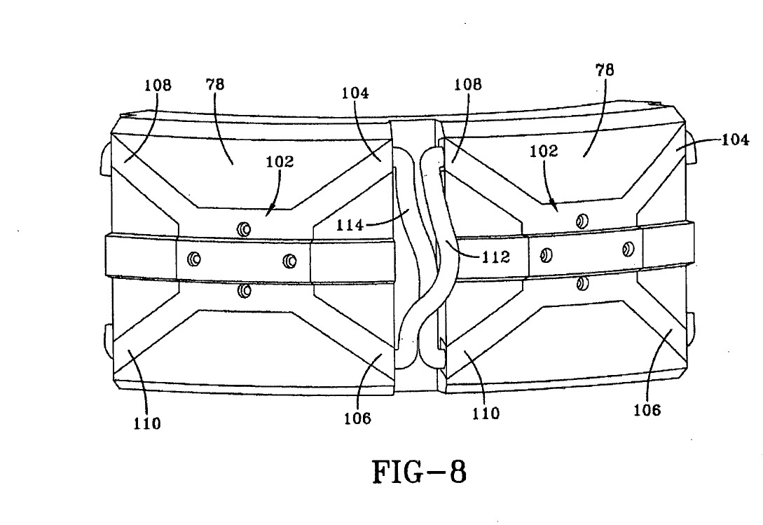

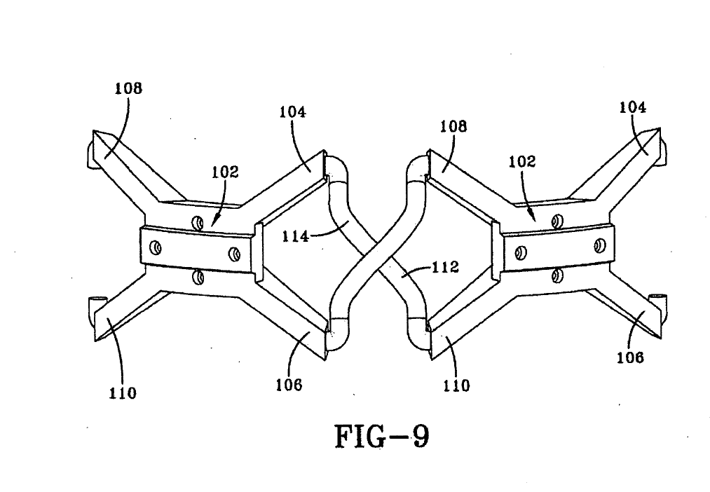

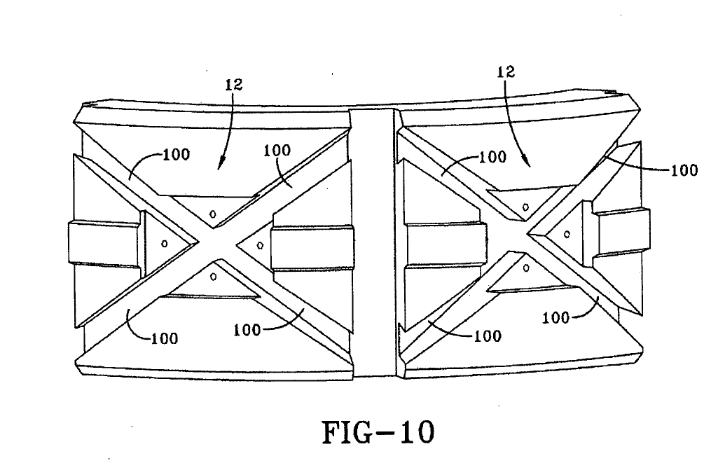

FIGS. 8-10 illustrate a second embodiment of the invention. FIG. 8 illustrates the outer radial surface 78 of the segments 12. As shown in FIG. 10, the outer radial surface of the segments 12 have an X shaped channel 100. Received in the X shaped channel is an X shaped coupling 102. The X shaped coupling has two ports 104, 106 on one side, and two ports 108, 110 on the other side. An X shaped coupling is received in the channel of each segment. The couplings are connected together by cross members 112, 114. Cross member 112 joins upper coupling port 108 to lower coupling port 106 located on an adjacent coupling. Cross member 114 joins upper coupling port 104 to lower coupling port 110 of an adjacent coupling. The X shaped couplings on each segment are thus connected together with the cross members forming a manifold to conduct a fluid medium therein. The fluid medium may be steam or other fluid as desired. The invention is not limited to the X shaped couplings, as other shapes would work for the invention.

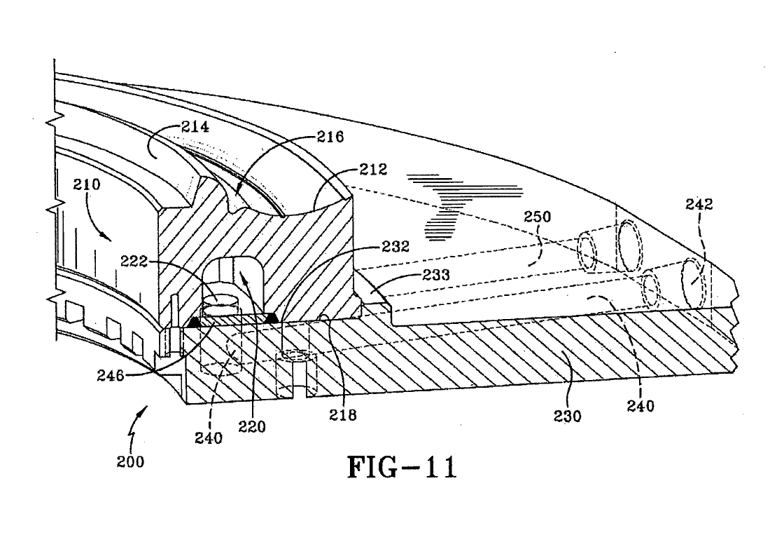

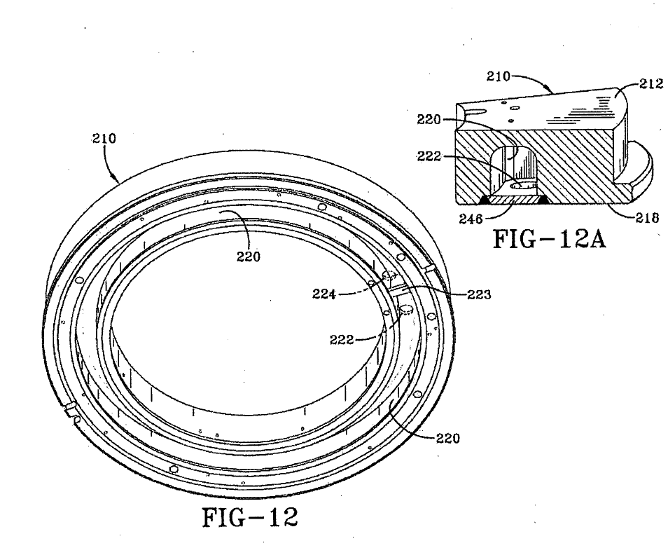

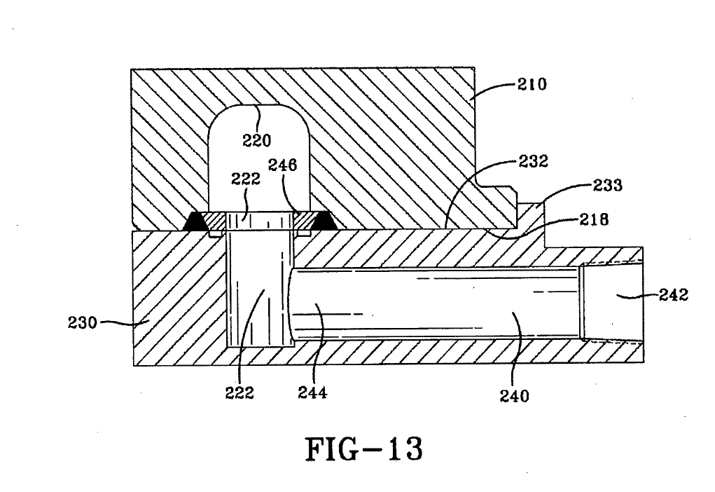

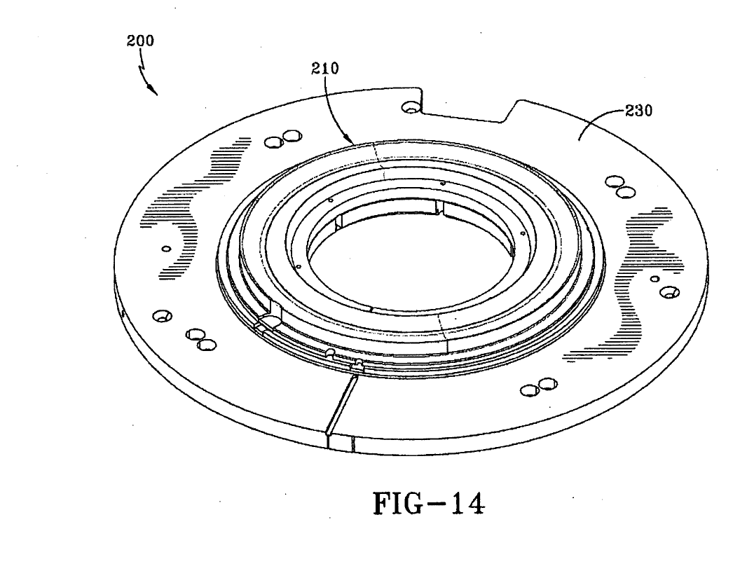

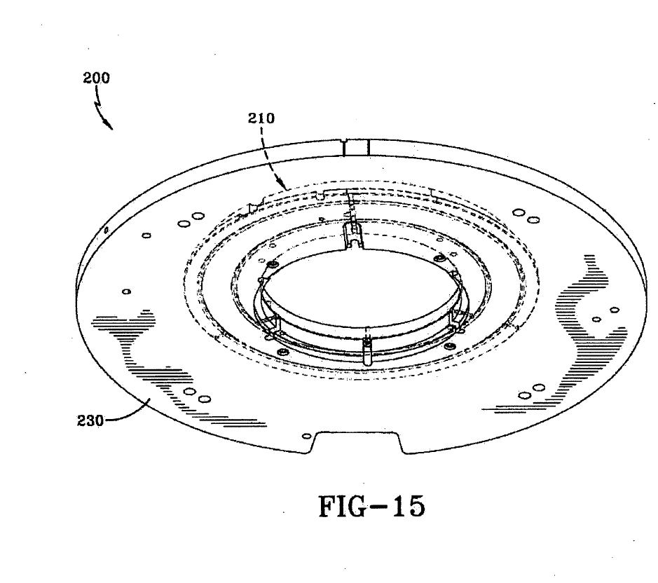

A third embodiment of a mold of the present invention is shown in FIGS. 11-15. FIG. 11 illustrates an improved sidewall plate assembly 200 suitable for use in any type of conventional mold having a sidewall plate, whether segmented or not. The mold sidewall plate of the present invention may also be used in any of the mold embodiments as described above. The improved assembly comprises a mold sidewall plate 210 which includes an outer mold surface 212 for mating with the bead area of a green tire to be cured The mold sidewall plate 210 further comprises a channel 220 which has an opening on an inner surface 218 and forming a recess which extends radially outward towards surface 212. The channel 220 is preferably annular and is preferably located opposite the bead ring split 214. However, the channel may have other shapes and locations. The channel 220 has an inlet 222 and an outlet 224. Preferably the inlet is located adjacent the outlet but separated by a divider wall 223, so that a heat conducting medium such as steam can traverse almost the entire annular passageway of the sidewall plate 210. FIG. 12 illustrates one example of the channel configuration. As shown in FIG. 11, the mold sidewall plate 210 cooperates with a lower plate 230 in order to form an enclosed annular passageway 220. The lower plate 230 has an upper face 232 having a radial lip 233 for seating the inner surface 218 of the sidewall plate 210 therein.

The lower plate 230 further comprises inlet and outlet channels 240, 250 which may be oriented in a radial direction. The inlet channel 240 has an inlet end 242 for receiving a fluid heat transfer medium such as steam, and an outlet end 244 in fluid communication with the inlet 222 of channel 220. A gasket or other sealing means 246 may be provided between the channel inlet 242 and the mold bead inlet. Thus the upper face of the lower plate together with the channel 220 form an annular shaped cavity for conducting a heat transfer medium such as steam, therein. The steam or medium is conveyed to the cavity via the lower plate inlet channel 240. The heat conducting medium circulates around the sidewall plate in the annular channel 220. The steam or fluid medium exits the ring 210 via outlet 224 and into channel 250 on lower plate. Alternatively, the heat transfer medium could also be conveyed to an opening in the inner annulus 252 of the mold bead ring. The annular cavity could also be formed completely within the sidewall plate 210, with channel openings on the inner annulus.

The sidewall plate of the present invention can be used in conventional molds which have a sidewall plate. The invention can be utilized in both the upper and lower sidewall plate positions, or just one (for example, the lower) position. The invention could also be extended to the mold bead rings.

While a certain representative embodiment and details have been shown for the purpose of illustrating the invention, it will be apparent to those skilled in the art that various changes and modifications may be made therein without departing from the spirit or scope of the invention.

What is claimed is:

1. A mold comprising a plurality of segments arranged to form an annular cavity to mold a tire, the segments comprising an inner face for molding the tread, the mold further comprising one or more sidewall plates, wherein at least one of said sidewall plates has an interior channel having an inlet and an outlet, said channel forming fluid manifold for circulating a fluid medium.

2. The mold of claim 1 wherein the channel is annular.

3. The mold of claim 1 wherein the channel is annular and extends substantially in the range of 320 to 350 degrees.

4. The mold of claim 1 wherein the sidewall plate further comprises a projection, and wherein the channel is located opposite the projection.

5. A mold comprising an annular cavity to mold a tire, the mold further comprising one or more sidewall plates, wherein at least one of said sidewall plates has an recessed channel having an inlet and an outlet, said sidewall plate having an inner surface in engagement with an annular surface of a container plate, wherein the recessed channel and the annular surface of the container plate form a fluid manifold, for circulating a fluid manifold for circulating a fluid medium.
